(19) United States
(12) Patent Application Publication
(10) Pub. No.: US 2007/0095027 A1
(43) Pub. Date: May 3, 2007

(54) Automatic cleaning system for filtration of an air circulation system

(76) Inventor: Robert Liva, Dallas, TX (US)

Correspondence Address: MICHAEL L. DIAZ, P.C., 555 REPUBLIC DRIVE, SUITE 200, PIANO, TX, 75074, US

(21) Appl. No.: 11/263,352

(22) Filed: Oct. 31, 2005

(51) Int. Cl. B01D 46/04

(52) U.S. Cl. 55/301

(57) ABSTRACT

An automatic cleaning system for a filtration system of an air delivery system is disclosed. The automatic cleaning system includes a filter constructed of a fine mesh material. The filter is mounted within a track running the width of the filter. An air intake device is mounted in the track and is driven along the track by a motor. The air intake device provides suction to remove particles captured by the filter within the air delivery system. The air intake device stores the removed particles in a collection tank. The automatic cleaning system may be utilized in an air conditioning unit having a filter or a clothes dryer having a lint tray.

### BACKGROUND OF THE INVENTION

1. Field of the Invention

This invention relates to air filtration systems. Specifically, and not by way of limitation, the present invention relates an automatic cleaning system for an air circulation system.

2. Description of the Related Art

There are a wide variety of products and appliances which utilize air circulation systems incorporated with a filtration mechanism. For example, heating, ventilation, air condition (HVAC) or air delivery systems oftentimes utilize a filtration system to cleanse the air traveling through the HVAC system. It is critically important that the air delivered to a conditioned room be cleaned prior to pumping the air into the room. Occupants of the room may be susceptible to contaminates in the air. If the air is not properly filtered, the contaminants may be brought directly to the conditioned room, to the detriment of the health of the occupants. Additionally, HVAC systems often use a filter covering a portion of the duct works to cleanse the air. If the filter is not periodically replaced, the duct becomes clogged, thereby preventing the efficient flow of air through the duct. A dirty filter may act as a blockage to the duct, which may significantly increase energy costs. Also, when a dirty filter is not timely replaced, the filter often acts as a sail which eventually folds or collapses. This collapsed filter allows all the air, without any filtration, to enter through the duct and eventually pass uncleansed to the conditioned room. Without proper filtration of the air, the dirty air may also contaminate and damage the evaporator coils of the air conditioning unit. Therefore, it is extremely important for the filters in an air condition system to be regularly checked and replaced. Unfortunately, because such filters are not easily accessible nor are the filters within sight, the task of replacing the filter is easily forgotten.

In another example, lint trays are used to remove lint from the ducts of appliances such as dryers. The dryers use a lint trap which includes a fine mesh grid to filter out the lint which collects from clothes dried within the dryer. This lint tray, in a similar manner as the filter in an air conditioning system, must be periodically cleaned and checked. If the lint collected in the lint tray is not constantly removed, the lint builds up in the tray, which reduces the flow of air and significantly increases the energy cost to run the dry.

In still another example, many appliances, such as refrigerators run a cooling system with a refrigerant coil to cool the interior of the refrigerators. These coils are difficult to access and, thus, are easily forgotten in cleaning. Without properly and periodic cleaning of these coils, the performance and efficiency of the appliance is reduced.

Another significant risk which may occur without proper replacement of filters or cleaning of lint trays is fire. It has been found that a significant percentage of all residential fires are caused by lint buildup in dryers or dirty filters. Thus, it is critically important that a filter or lint tray be periodically and consistently replaced.

Most of these air conditioning systems use some form of a filter to clean the conditioned air. But because the filter is easily forgotten, the task of replacing or cleaning filtration systems is not accomplished. A device is needed which automatically cleans the filtration system of an air conditioning system or other air delivery system.

Although there are no known prior art teachings of a device such as that disclosed herein, prior art references that discuss subject matter that bears some relation to matters discussed herein are U.S. Pat. No. 4,285,353 to Colomer (Colomer) and U.S. Patent Application Publication Number 2005/0150382 to Sheehan et al. (Sheehan).

Colomer discloses a filter with an automatic cleaning mechanism using a hydraulically actuated sprinkling device. A carriage carrying tubes is driven by a hydraulic double-acting actuator. The working chambers of the hydraulic actuator are connected by off-take pipers to the cleaning liquid distributing circuit. Although Colomer discloses cleaning a filter, Colomer suffers from the advantage of utilizing sprinklers and water to clean the filter. The use of water increases the cost of any air conditioning system and increases the change of damage within the system. Colomer does not teach or suggest a system which automatically cleans filtration systems through the use of a vacuum system.

Sheehan discloses a filter system where the filter media is automatically replaced and where the used filter media is automatically deposed in a sealed container. However, rather than cleaning the filter, Sheehan discloses the automatic replacement of the filter. Sheehan does not teach or suggest automatically cleaning a filter.

A cleaning system is needed which automatically cleans a filtration system without the need for water or replacement of a filter. The device should be able to be modified into existing air conditioning systems. Thus, it would be a distinct advantage to have a filtration system which is automatically cleaned without intervention by an operator. It is an object of the present invention to provide such an apparatus.

### SUMMARY OF THE INVENTION

In one aspect, the present invention is an automatic cleaning system of a filtration system for an air delivery system. The automatic cleaning system includes a filter for filtering air drawn through the air delivery system and an air intake device for cleaning the filter. The air intake device provides suction to the filter to remove particles from the filter. The air intake device may be moveable within a track positioned adjacent the filter. The air intake device may be driven by a motor. Additionally, the cleaning system may be used in an air conditioning system or a clothes dryer.

In another aspect, the present invention is an air conditioning system having an automatic cleaning system for a filtration system. The air conditioning system includes a blower motor providing conditioned air through a duct. The duct has a valve mounted on an exterior wall of the duct. A filter for filtering air drawn through duct is positioned within the duct. An air intake device is utilized for cleaning the filter. The valve is connected to a conduit leading from the valve to the air intake device. A plurality of closeable louvers are mounted adjacent the filter. When cleaning the filter, the closeable louvers are closed, the valve is opened, and the blower motor provides suction to the air intake device. The air intake device thus removes particles from the filter. The air intake device may be positioned and moved within a track mounted adjacent the filter. The air intake device, valve and louvers may be automatically controlled by a control board.

In still another aspect, the present invention is a dryer having an automatic cleaning system for a lint filtration system. The dryer includes a dryer having an exhaust. The dryer runs hot air through an interior portion of the dryer to dry clothes. A lint filter is utilized for filtering air exhausted from the dryer. An air intake device is used for cleaning the filter by providing suction from a connected vacuum device to the filter to remove lint from the filter.

### BRIEF DESCRIPTION OF THE DRAWINGS

FIG. 1 is a front perspective view of an air delivery system in the preferred embodiment of the present invention;

FIG. 2 is a front perspective view of the air delivery system of FIG. 1 with the louvers in the closed positioned in the preferred embodiment of the present invention;

FIG. 3 is a partial front perspective view of the mesh filter of FIG. 1 removed from the duct;

FIG. 4 (prior art) is a front perspective view of a clothes dryer unit in an existing system;

FIG. 5 is a rear perspective view of the dryer unit in a first alternate embodiment of the present invention; and

FIG. 6 is an enlarged partial front perspective view of the automatic cleaning system of FIG. 5.

### DESCRIPTION OF THE INVENTION

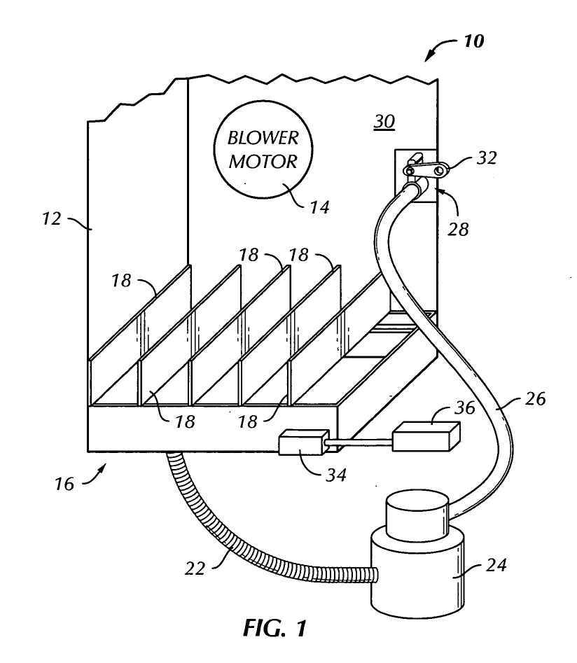

The present invention is an automatic vacuum mechanism for cleaning a filtration system of an air delivery system. FIG. 1 is a front perspective view of an air delivery system 10 in the preferred embodiment of the present invention. The air delivery system may be a conventional air conditioning system having a duct 12 and a blower motor 14. The duct is used for running conditioned air into a room or plurality of rooms. In conventional air conditioning units, the conditioned air passes through a fibrous filter which collects contaminants in the air. However, after a period of time, the filter must be replaced. The present invention utilized an automatic cleaning system 16 for a filtration system of the air conditioning system, thereby eliminating the requirement to periodically replace filters.

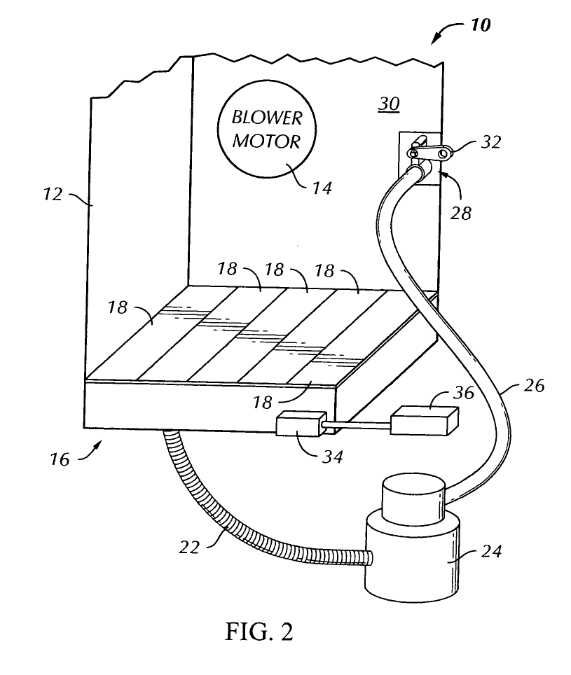

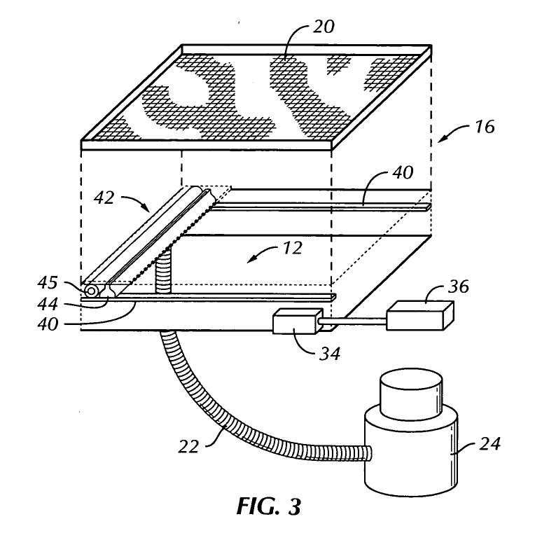

The automatic cleaning system includes a plurality of louvers 18 arranged in lateral formation within the duct 12. As depicted in FIG. 1, the louvers are in an open position. The louvers may be rotated from the open position shown in FIG. 1 to the closed position shown in FIG. 2. Additionally, the automatic cleaning system includes a mesh filter 20 (see FIG. 3) located below the louvers 18. A suction hose 22 is located below the filter 20 and leads to a collection tank 24. The collection tank includes an intake hose 26 which runs to an opening 28 on a wall 30 of the duct 12 and is positioned near the blower motor 14. At the juncture of the intake hose 26 and the opening 28 is a closeable valve 32. The automatic cleaning system also includes a motor 34 which is controlled by a control board 36. The control box may also be electrically connected to the valve.

FIG. 2 is a front perspective view of the air delivery system 10 with the louvers in the closed positioned in the preferred embodiment of the present invention. As discussed above, the louvers may be rotated to the closed positioned. The louvers may be closed by activating the motor 34 to drive the louvers to the closed position. With the louvers in the closed position, the filter may be cleaned. The louvers may be moved in a variety of ways. In the preferred embodiment of the present invention, the louvers are moved through activation of a solenoid. In an alternate embodiment, the motor 34 or a separate motor closes the louvers by a pulley belt system (not shown). With the louvers in the open position, the air delivery system 10 operates normally to provide conditioned air to a room.

FIG. 3 is a partial front perspective view of the mesh filter 20 removed from the duct 12. During operation of the air delivery system 10, the mesh air filter 20 is positioned within the duct 12. Preferably, the filter 20 is positioned adjacent a track 40. An intake suction device 42 is located within the track 40.

The intake suction device is connected to the suction hose 22 and includes an intake 44 which runs along the width of the track. The intake is approximately the same width as the filter. The intake suction device moves laterally along the track 40. In the preferred embodiment of the present invention, the track is a round steel rail. However, it should be understood by those skilled in the art that the track may be any device which allows the movement of the intake suction device across length of the filter. The intake suction device is driven by the motor 34, preferably by a pulley system (not shown), in a similar fashion as a scanner utilizes a scanning device to move across the length of an object scanned. The intake suction device provides suction through the intake in a similar manner as a vacuum cleaner sucks dirt from a carpet. The intake suction device then moves along the track to clean the entire filter. Preferably, the filter is constructed of a fine polyester screen mesh having holes ranging from 40 to 410 holes per square inch and encapsulated by a wire cloth. The polyester screen mesh prevents contaminates from passed through the filter while allowing the passage of air through the duct. However, any filter may be used to screen out contaminates. To assist in the collection of dirt within the intake suction device, a bristle brush 45 may be affixed along the intake portion of the intake suction device. The intake suction device then sucks the dirt and contaminates collected from the filter into the collection tank 24. The movement of the intake suction device and louvers is controlled by the control board 36 which controls the motor 34. The intake suction device receives suction from the blower motor. With the louvers in the closed position and the valve in the open position, the blower motor produces a suction which draws air through the intake house 26 through the collection tank 24 and the suction hose 22. However, although the blower motor is preferred for creating a suction force, any device, such as a separate vacuum device, may be utilizing to create the suction force.

With reference to FIGS. 1-3, the operation of the automatic cleaning system 16 will now be explained. During normal operation of the air delivery system 10, the louvers 18 are positioned in the open position (see FIG. 1). In this configuration, air flow is allowed to pass through the duct 12 and across the filter 20. The filter 20 collects various dirt particles and other contaminates. Periodically (e.g., daily), the filter is automatically cleaned by a suction device. In the preferred embodiment of the present invention, the filter 20 is cleaned by the intake suction device 42 which runs along the track 40. Alternatively, the control board 36 may optionally include a timer which determines when the filter is cleaned. When it is determined when the filter is to be cleaned, the control board sends a signal to the valve 32 to open the valve. However, in the preferred embodiment of the present invention, the filter is cleaned at an end of the air delivery cycle (e.g., when the air conditioning unit turns off after heating or cooling a room/house). During normal use of the air delivery system, the valve is in the closed position. Additionally, the louvers are closed (see FIG. 2), thereby preventing air flow, which normally originates from the blower motor 14. The motor may also be used for driving the intake suction device 42 along the track 40. The motor may allow the intake suction device to move in both directions and several times across the track to ensure the cleanliness of the mesh filter. The control board may be used to optionally control the blower motor. To ensure that a suction force is created within the automatic cleaning system 16, the blower motor should be on and the valve opened. The contaminates are then collected in the collection tank 24. In the preferred embodiment, the collection tank includes its own filter for gather the dirt and particles. Occasionally, the collected contaminates are removed from the tank and filter. To assist in cleaning the air delivered by the air condition system, the delivered air may be optionally subjected to ultraviolet light.

When the cleaning operation is complete, the louvers are opened, the valve is closed, and the intake suction device is positioned along the side of the duct to allow the unobstructed passage of air through the duct and filter.

It should be understood that any suction device may be used to automatically clean the filter. For example, a separate vacuum device may be used, rather than utilizing the blower motor of the air delivery system. Additionally, the present invention may be implemented in other devices, such as lint trays of dryer units or coils located on household appliances. The basic concept of a suction device to clean filtration systems is provided with the present invention. Additionally, although a fine mesh filter is preferred, any material which allows the passage of air, while preventing most particles from passing, may be used. Additionally, the present invention may be utilized on a commercial system, such as for a building, factory, or office.

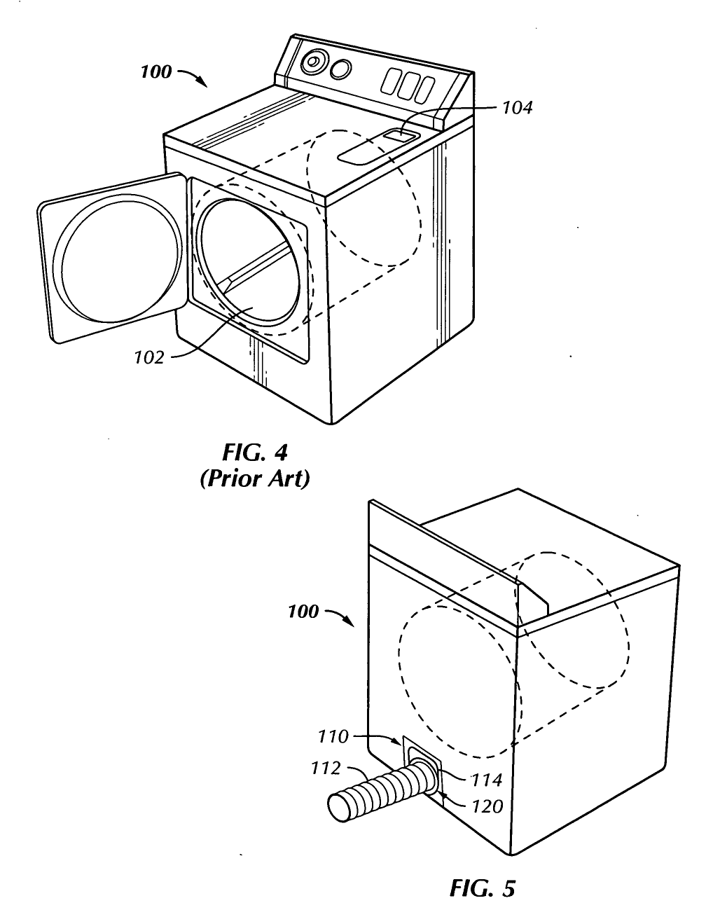

FIG. 4 is a front perspective view of a clothes dryer unit 100 in an existing system. Electric and gas heated clothes have become common household appliances during the past several decades for drying clothes after washing. The dryer unit essentially operates by tumbling wet clothes in a large revolving cylinder 102 while forcing hot air through the cylinder to pick up the moisture from the clothes and carry it out of the dryer. It is common to vent or exhaust the warm humid air to the outside of the house. However, exhaust air from the dryer often contains a certain amount of lint which is picked up from the clothes. Most dryer units include a lint trap 104 to eliminate the lint from the exhaust air. Without some type of removal of this lint from the lint trap, the lint would enter the environment of the house which is both unsafe and presents a fire hazard. Thus, an operator of the dry unit must periodically clean the lint trap. As discussed above, the operator oftentimes forgets to clean this trap. A device is needed to automatically clean the lint traps.

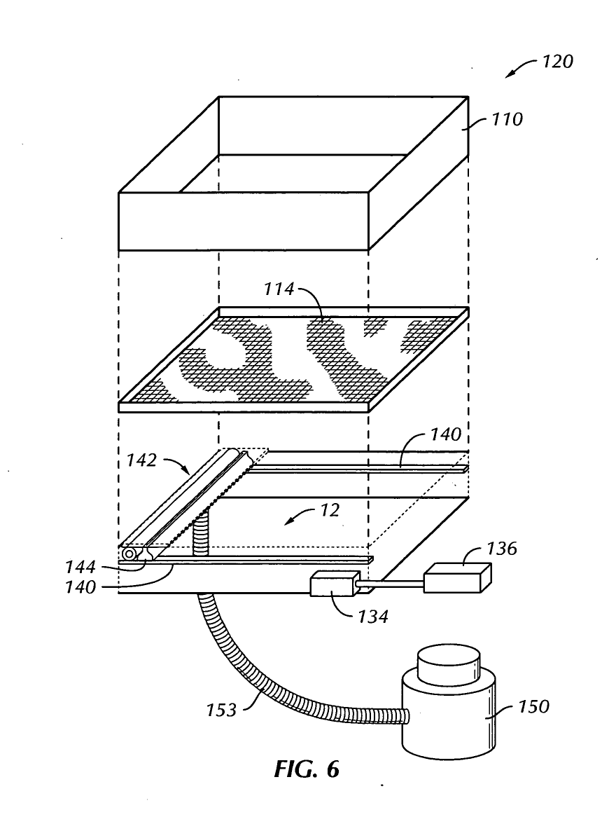

FIG. 5 is a rear perspective view of the dryer unit 100 in a first alternate embodiment of the present invention. The dryer unit includes an exhaust manifold 110 located at the rear of the dryer unit. The exhaust air is typically exhausted through a flexible tube 112 out to the environment, outside of the house. The present invention may provide a lint filter 114 positioned adjacent the exhaust manifold. The lint filter preferably includes an automatic cleaning system 120 (see FIG. 6), which cleans the lint filter in a similar manner as described for the automatically cleaning system 16 (FIG. 3).

FIG. 6 is an enlarged partial front perspective view of the automatic cleaning system 120 of FIG. 5. The cleaning system 120 is preferably affixed to the exhaust manifold 110 of the dryer unit 100. However, it should be understood that the cleaning system 120 may be affixed anywhere on the dryer unit which enables the exhaust air of the dryer unit to pass through the lint filter 114. As shown in FIG. 6, the lint filter 114 is shown removed from the cleaning system. The lint filter is preferably an aluminum screen which is positioned within a track 140. The track 140 is positioned adjacent the exhaust manifold to allow the free passage of exhaust air. The cleaning system also includes the intake suction device 142 which runs allow the track 140. Suction is provided through the intake 144 to clean the lint filter 114. The intake suction device 142 is driven by a motor 134 controlled by a control board 136. Suction may be provided by a vacuum device 150 which is connected to the intake suction device 142 by a suction hose 152. Although a separate vacuum device is depicted in FIG. 6, any suction device may be used, such as the motor used for heating the dryer unit. The vacuum device provides suction force to the intake suction device 142 to remove lint from the lint filter. When not in use, the intake suction device is positioned on the side of the track to allow free passage of the exhaust air through the flexible tube 112 out to the environment.

With reference to FIGS. 4-6, the operation of the automatic cleaning system 120 will now be explained. During normal operation of the dryer unit 100, exhaust air passes through the manifold 110 and across the lint filter 114. The lint filter 114 collects various particles and lint. Periodically (e.g., daily), the filter is automatically cleaned by a suction device. In this alternate embodiment of the present invention, the filter 114 is cleaned by the intake suction device 142 which runs along the track 140. The control board 136 may optionally include a timer which determines when the filter is cleaned. Alternatively, the lint filter may be cleaned after each drying cycle. When it is determined when the filter is to be cleaned, the control board sends a signal to the motor to drive the intake suction device 42 along the track 40. The motor may allow the intake suction device to move in both directions and several times across the track to ensure the cleanliness of the mesh filter. The lint and particles are then collected in a storage area of the vacuum device 150. The storage device may include a filter to collect the lint and particles. Occasionally, the collected particles are removed from the vacuum device. When the cleaning operation is complete, the intake suction device is positioned along the side of the manifold to allow the unobstructed passage of air through the flexible tube and filter. Although an example of a residential dryer has been illustrated, the present invention may be implemented upon a commercial system which may optionally share a single large lint filter system.

The present invention provides many advantages over existing filtration systems. The present invention enables the automatic cleaning of filters without the intervention of an operator or the use of water. The present invention is easily implemented on existing air delivery and appliances without major modifications to the filtration systems. The present invention provides for efficient use of appliances and air delivery systems and prevents the accumulation of particles, thereby decreasing fire hazards.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. An automatic cleaning system of a filtration system for an air delivery system, the automatic cleaning system comprising:
a filter for filtering air drawn through the air delivery system; and
an air intake device for cleaning the filter;
whereby, the air intake device provides suction to the filter to remove particles from the filter.

2. The automatic cleaning system of a filtration system of claim 1 wherein the air intake device moves along a track running an approximate width of the filter.

3. The automatic cleaning system of a filtration system of claim 1 wherein the air intake device includes a vacuum to provide a suction force through the intake device to remove particles from the filter.

4. The automatic cleaning system of a filtration system of claim 3 wherein:
the air delivery system is a air conditioning system having a blower motor; and
the vacuum device is the blower motor providing a suction force to the intake device.

5. The automatic cleaning system of a filtration system of claim 1 wherein the filter is constructed of a mesh material which allows passage of air through the filter and prevents passage of particles.

6. The automatic cleaning system of a filtration system of claim 5 wherein the mesh filter is constructed of silk mesh.

7. The automatic cleaning system of a filtration system of claim 1 further comprising:
a track running an approximate width of the filter, the air intake device moving within the track; and
a motor to drive the air intake device.

8. The automatic cleaning system of a filtration system of claim 7 further comprising a control board to periodically operate the motor to drive the air intake device for cleaning the filter.

9. The automatic cleaning system of a filtration system of claim 1 wherein:
the air delivery system is an air conditioning system having a blower motor and a duct for directing an air flow through the air conditioning system;
the duct having a closeable valve with a conduit leading from the valve to the air intake device;
a plurality of closeable louvers mounted adjacent the filter;
whereby the closeable louvers are closed, the valve is opened, and the blower motor provides suction to the air intake device when cleaning the filter.

10. The automatic cleaning system of a filtration system of claim 9 further comprising a control board for automatically controlling a position of the valve and louvers.

11. The automatic cleaning system of a filtration system of claim 10 further comprising a motor for driving the air intake device within a track positioned adjacent the filter.

12. The automatic cleaning system of a filtration system of claim 1 wherein:
the air delivery system is installed in a dryer; and
the filter is a lint filter for collecting lint from exhaust air exiting the dryer.

13. The automatic cleaning system of a filtration system of claim 12 wherein the filter is mounted adjacent an exhaust manifold of the dryer.

14. The automatic cleaning system of a filtration system of claim 12 wherein the air intake device is connected to a vacuum device providing suction to the air intake device.

15. The automatic cleaning system of a filtration system of claim 1 further comprising a collection tank for collecting particles removed by the air intake device, the collection tank connected to the air intake device by a conduit.

16. An air conditioning system having an automatic cleaning system of a filtration system, the air conditioning system comprising:
a blower motor providing conditioned air through a duct, the duct having a valve mounted on an exterior wall of the duct;
a filter for filtering air drawn through duct;
an air intake device for cleaning the filter;
the valve connected to a conduit leading from the valve to the air intake device;
a plurality of closeable louvers mounted adjacent the filter;
whereby the closeable louvers are closed, the valve is opened, and the blower motor provides suction to the air-intake device when cleaning the filter, the air intake device removing particles from the filter.

17. The air conditioning system of claim 16 further comprising a collection tank connected to the air intake device, the air intake device storing the particles sucked from the filter in the collection tank.

18. The air conditioning system of claim 17 further comprising a track, the air intake device mounted in the track and moving an approximate width of the filter.

19. A dryer having an automatic cleaning system of a lint filtration system, the dryer comprising:
a dryer having an exhaust, the dryer running hot air through an interior portion of the dryer to dry clothes;
a lint filter for filtering air exhausted from the dryer; and
an air intake device for cleaning the filter;
whereby, the air intake device provides suction to the filter to remove lint from the filter.

20. The dryer of claim 19 further comprising a vacuum device providing suction to the air intake device.
